(19) United States
(12) Patent Application Publication
(10) Pub. No.: US 2011/0102579 A1
(43) Pub. Date: May 5, 2011

(54) STEERING CONTROL LEADING APPARATUS USING LANDMARK AND METHOD THEREBY

(75) Inventors: Jun-Yong SUNG, Seoul (KR); Rock-Won KIM, Daejeon (KR); Seung-Ik LEE, Daejeon (KR); Myung-Chan ROH, Daejeon (KR); Sung-Hoon KIM, Daejeon (KR); Min-Hong HAN, Yongin-si (KR)

(73) Assignee: Electronics and Telecommunications Research Institute, Daejeon-city (KR)

(21) Appl. No.: 12/912,933

(22) Filed: Oct. 27, 2010

(30) Foreign Application Priority Data
Nov. 3, 2009 (KR) 10-2009-0105519

(51) Int. Cl. H04N 7/18; G06K 9/00

(52) U.S. Cl. 348/135; 382/103; 348/E07.085

(57) ABSTRACT

Disclosed is a steering control leading apparatus using a landmark when a car travels. The steering control leading apparatus includes: a coordinate controller that analyzes images obtained by photographing the landmark installed on a road by a photographing apparatus installed in a car to generate current coordinate data and current driving lane data of a car; a lane controller that compares the current driving lane data or the current coordinate data received from targeted coordinate data and a coordinate controller to generate determined result data determining whether the car is normally driven; and a display unit that displays the current coordinate data, and the targeted coordinate data, or the data indicating whether the car is normally driven

### CROSS REFERENCE TO RELATED APPLICATIONS

This application claims priority to Korean Patent Application No. 10-2009-0105519 filed on Nov. 3, 2009, the entire contents of which are herein incorporated by reference.

### BACKGROUND OF THE INVENTION

1. Field of the Invention

The present invention relates to a technology of enabling a driver to drive a car toward a center of a lane by assisting recognition of a lane when it is difficult for a driver to perform a steering control by directly recognizing a lane at the time of driving a car due to heavy snow, heavy rain, or removal of indicated lane, and more specifically, to a technology capable of generating steering information and steering control leading commands to allow a driver to drive a car toward the center of the lane by photographing a landmark viewed on the road and calculating the photographed images.

2. Description of the Related Art

As the number of cars or the driving speed of a car is increased on various roads in and outside the country including a highway and an expressway, research on a technology for safe driving has been actively conducted. Factors threatening safe driving may include hazardous visibility of a car due to the indistinct indication of the lane, heavy rain, heavy snow, etc. when a car travels. In particular, there is a risk of remarkably increasing the probability of a traffic accident when a driver of a car cannot identify the road in the front view of a driver due to heavy rain, heavy snow, etc.

Therefore, a research on a technology capable of resolving the hazardous visibility for a driver has been conducted. As a representative technology, there has been proposed a technology of providing a car driving control, for example, a steering control or speed control information to a driver by assisting in the visibility for the driver or limiting driving of the car by the driver with a predetermined direction or speed by allowing a car to directly use an automatic control system. In order to control the steering or speed, a need exists for a technology of measuring the state of the road, the information on the lane, and the speed information by assisting in the visibility for the driver and providing them to the driver. Therefore, a research on the steering or speed control has been mainly made.

An example of currently used technologies of assisting in the visibility for the driver according to the related art is shown in FIG. 1.

Referring to FIG. 1, when it is difficult to safely drive a car because of hazardous front visibility due to an unpainted lane on the road surface, heavy rain or heavy snow, etc., there has been a method of burying a magnet bar 102 in the road surface, on which a car travels, at a predetermined interval and detecting the position of the magnet bars by a magnetic field detector such that it allows a car to travel along them. Further, there has been a method of installing a guide line 101 on the road surface. Meanwhile, as a sort of guide line 101, there has been well known the guide line 101 using a fluorescent material that is visibility assisting material during a dark state, a method of causing vibration to a car when a car deviates from the lane by installing ridges on the lane of the road surface, or a method of preventing snow from heaping on the portion of the lane even though heavy snow falls on the road surface by installing hot wires in the lane, etc.

However, the visibility assisting technology for the car driver according to the related art has the following problems. First, the method of installing the hot lines on the lane has little effect in assisting the visibility for the driver due to the hazardous visibility while in a dark state, heavy snow, or heavy rain that is substantially continuous. In addition, the method of preventing the car from deviating from the lane by installing ridges on the lane is insufficient in preventing the car from deviating from the lane since the driver can sense the information once deviation from the lane occurs only just before the car deviates from the lane. Further, the guide line 101 using the fluorescent material has also a problem in that there is little effect in assisting visibility similar to the method of installing the hot wires on the road surface.

In the case of the method of burying the magnet bars 102 on the road surface at a predetermined interval and detecting them by the magnetic field detector, the road surface should be perforated in order to bury the magnets, such that there is a risk of damage to the road due to cracks in the road, etc., and cannot sense the positions of the magnet bars in front of the car because of sensing only the magnet bars under the car, which causes a problem in allowing the car to stay in the lane and prevents the car from deviating from the lane. Therefore, an urgent need exists for a new technology in order to solve the problems.

### SUMMARY OF THE INVENTION

In order to solve the above problems, it is an object of the present invention to provide a technology of more efficiently and directly providing visibility information to a driver when visibility for the car driver is hazardous due to an unpainted lane on a road surface, heavy snow, or heavy rain when a car travels while previously sensing and predicting the visibility in front of the vehicle and providing it to the driver, thereby to maximize the visibility assisting effect for the driver and performing a visibility assisting function by using the state of the road as it is without needing to install other assisting apparatuses, thereby to obtain the economic effect.

In order to achieve the above object, according to the exemplary embodiment of the present invention, there is provided a steering control leading apparatus using a landmark, including: a photographing apparatus installed in a car that photographs the landmark installed on a road when a car travels; a coordinate controller that analyzes images of the photographing apparatus and generates the current coordinate data of the car; a lane controller that compares the targeted coordinate data of the car with the current coordinate data received from the coordinate controller to determine whether a car is normally driven and generate data indicating whether the car is normally driven; and a display unit that displays the current coordinate data received from the coordinate controller, the targeted coordinate received from the lane controller, and data indicating whether a car is normally driven.

Further, the coordinate controller and the lane controller calculates the current coordinate and the targeted coordinate based on an actual height of the landmark, a height indicating images, photographing magnification, a distance between the landmark and the car, a focus and a focal distance of the photographing apparatus, a central point of the photographing apparatus, a lane central line, a vertical distance between the landmark and the lane center line, a vertical distance between the landmark and a collimation line of the photographing apparatus, etc., and performs the steering control based thereon.

With the steering control leading apparatus using the landmark according to the exemplary embodiments of the present invention, it can obtain sensible information even in heavy rain or heavy snow by the beam generated from the landmark using the photographing apparatus installed in the car. In particular, the exemplary embodiments of the present invention use the street lamp basically installed on the road as the landmark, thereby making it possible to accurately provide visibility information to the driver without needing to install separate auxiliary apparatuses on the road side, thereby making it possible to achieve low cost implementation. In addition, the exemplary embodiment of the present invention previously informs the driver of the lane keeping direction by photographing the landmarks in front, thereby making it possible to provide the technology of preventing an accident that can be caused in keeping the lane or performing the steering control.

### BRIEF DESCRIPTION OF THE DRAWINGS

FIG. 1 shows an example of a steering control leading apparatus or a lane guide apparatus according to the related art;

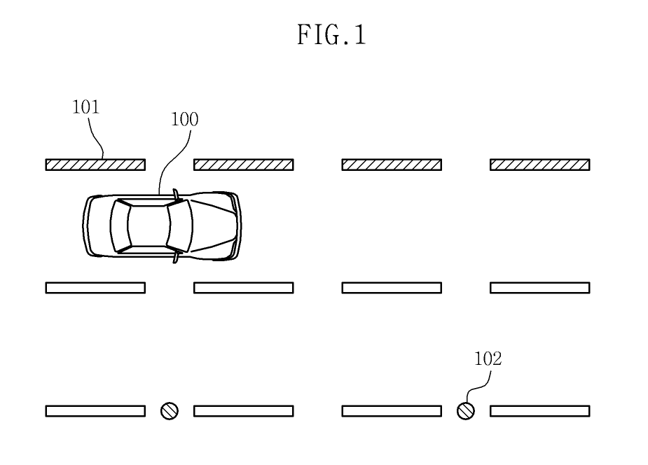

FIG. 2 shows an example of a driving of a car using a steering control leading apparatus using a landmark according to an exemplary embodiment of the present invention;

FIG. 3 shows the steering control leading apparatus using the landmark according to the exemplary embodiment of the present invention;

FIG. 4 is an operation method of generating current coordinate data and current travelling lane data by a coordinate controller using the steering control leading apparatus using the landmark according to the exemplary embodiment of the present invention;

FIG. 5 is an operation method of generating the targeted coordinate data by a lane controller using the steering control leading apparatus using the landmark according to the exemplary embodiment of the present invention;

FIG. 6 shows a display example of a display unit in the steering control leading apparatus using the landmark according to the exemplary embodiment of the present invention;

FIG. 7 shows an example of a data structure stored in a road information storage unit in the steering control leading apparatus using the landmark according to the exemplary embodiment of the present invention; and

FIG. 8 shows a flow chart of a steering control method using a steering control leading apparatus using a landmark according to an exemplary embodiment of the present invention.

### DETAILED DESCRIPTION OF THE PREFERRED EMBODIMENTS

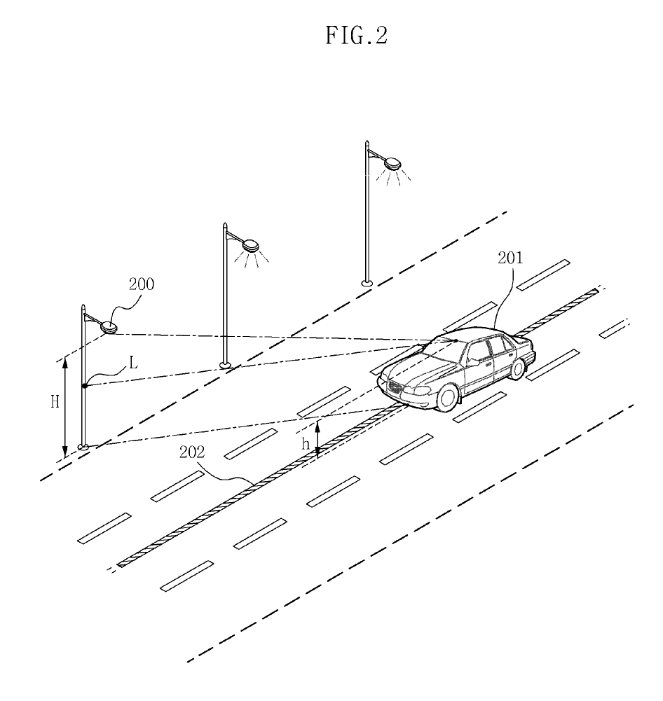

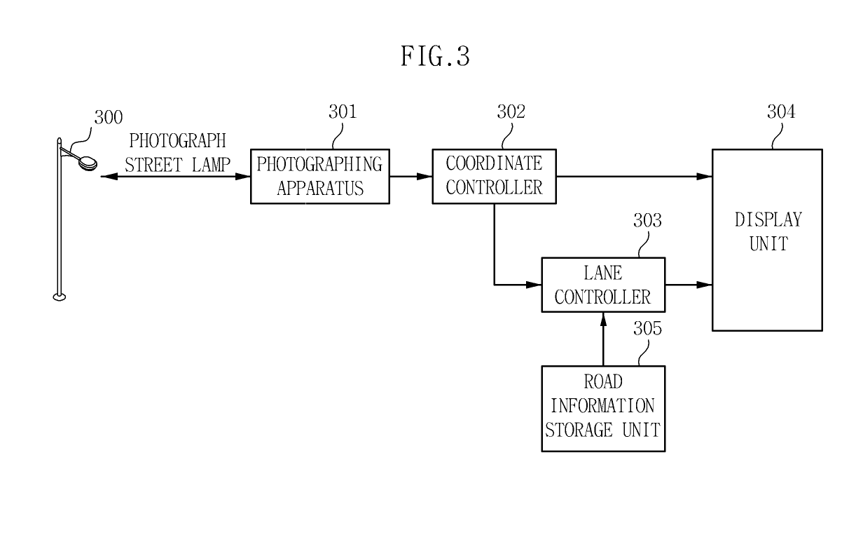

Hereinafter, a steering control leading apparatus using a landmark according to exemplary embodiments of the present invention will be described with reference to FIGS. 2 and 3.

The steering control apparatus according to the present invention generally includes an apparatus for performing all the functions that control car steering such as a guide of a lane, etc.

FIGS. 2 and 3 schematically show a driving type of a car using a steering control leading apparatus using a landmark according to exemplary embodiments of the present invention, information necessary to perform an operation, and an apparatus inside a car.

First, FIG. 2 shows a shape of a car 201 travelling on a road. The exemplary embodiment of the present invention provides an apparatus for assisting the travelling of the car while following a central line 202 of a lane on a general road. Therefore, the exemplary embodiment of the present invention can assist safe driving of the car 201 by performing a warning indication providing function when the car 201 deviates from the central line 202 of the lane, a function of preventing the control of a steering wheel exceeding a predetermined angle by directly controlling the steering by a processor such as an ECU, etc., in the car, or introducing an automatic travelling system.

In order to achieve the above object, that is, in order to travel the car 201 along the central line 202 of the lane, a photographing apparatus (no reference numeral) is installed at a portion having a predetermined height ‘h’ inside or outside the car, wherein the photographing apparatus photographs a landmark 200 having a predetermined height ‘H’ to determine whether the car travels on the road while maintaining the central line 202 of the lane based on the photographing images of the landmark 200.

The landmark 200 means a photographing mark that is installed the roadside or the central line of the road at a predetermined interval. The exemplary embodiment of the present invention uses the street lamp 200, which can be generally installed at the roadside or the central line of the road, as the landmark. Since the street lamp 200 generates a sensible beam even in the case of night, heavy rain, and heavy snow, the photographing apparatus installed in the car 201 senses the beam to calculate the height of the street lamp 200 such that it may be an applicable apparatus as the landmark. However, in addition to the street lamp 200, the dedicated landmark installed at the roadside or the central line of the road may be used in the exemplary embodiment of the present invention and a lighting apparatus that can be sensed by the photographing apparatus even in the case of night, heavy rain, or heavy snow should be installed in the landmark.

FIG. 3 shows the steering control leading apparatus using the landmark for performing the above-mentioned functions according to the exemplary embodiment of the present invention.

Referring to FIG. 3, the steering control leading apparatus is installed at a predetermined portion of the car to photograph a landmark 300 and may include a photographing apparatus 301 that can send out images photographing the landmark 300. The photographing apparatus 301 may include a general purpose camera. Preferably, as the photographing apparatus 301, there may be a photographing apparatus in a black box for a car of which use frequency is rapidly increased is installed in a window in front of the car to photograph and store the front of the road when the car is driven. The photographing apparatus 301 performs a function of photographing the landmark 300 installed on the road, analyzing the images, and sending them out in real time.

The photographing apparatus 301 may be installed at any place to photograph the landmark 300 viewed in front of the car. In the exemplary embodiment of the present invention, the photographing apparatus 301 may be installed at the center of the upper end of the window in front of the car. Preferably, the photographing apparatus 301 may be installed at the position of a rear view mirror (referred to as a back mirror). Since the object of the present invention is to travel the car along the central line of the lane, the above-mentioned positions of the rear view mirror is at the left and right center of the car such that the photographing apparatus 301 is also installed at the position of the rear view mirror, thereby making it possible to travel the car along the central line of the lane.

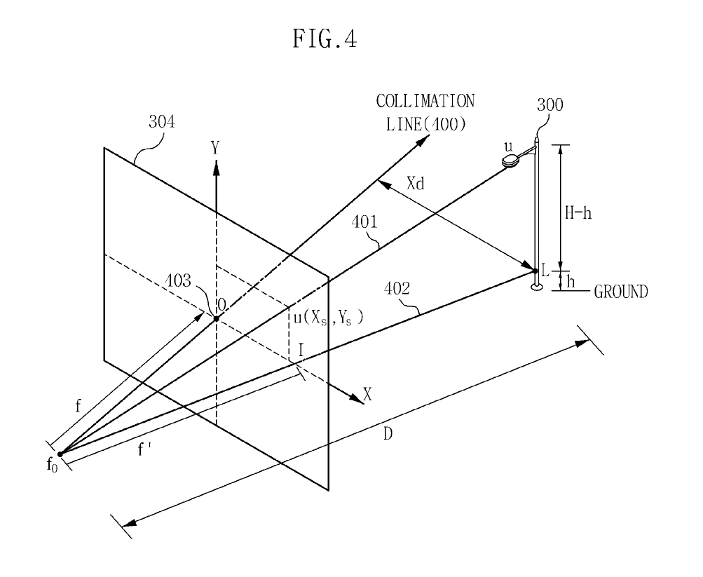

The steering control leading apparatus using the landmark may also include a coordinate controller 302. The coordinate controller 302 has a set orthogonal coordinate system to be described below and analyzes the photographed images received from the photographing apparatus 301 based on the orthogonal coordinate system, thereby generating the current coordinate data of the car. The method for generating the current coordinate data of the car will be described with reference to FIG. 4.

FIG. 4 shows the method for allowing the coordinate controller 302 to generate the current coordinate data of the car based on the photographing apparatus.

Referring to FIG. 4, the coordinate plane 304 on which the coordinate axis is set means the surface position of a lens, etc., on which the photographing apparatus 301 is basically positioned. At the time of setting the coordinate axis, an original point 0 means the central point of the photographing apparatus 301. Since the photographing apparatus 301 also has a focus ID, the virtual focus f0 may be provided at the rear surface of the photographing apparatus 301. A distance between the focus f0 of the photographing apparatus 301 and the central point of the photographing apparatus 301 may be set to a focal distance f. The original point 0, the focus f0, and the focal distance f may be varied according to the kind of the photographing apparatus 301.

An X-axis of the coordinate plane 304 on which the coordinate axis is set according to the surface position of the lens on which the photographing apparatus 301 is positioned means a line parallel with the road surface on which the car travels. When setting the X-axis of the coordinate plane 304, a line parallel with the road surface and passing through the original point 0 may be set to an X-axis by analyzing the photographed images and extracting the road surface when photographing the front road by the photographing apparatus 301. However, in addition to the above method, any method capable of setting a line that is parallel with a ground on which a car is positioned, such as a line that is parallel with a line connecting between points where the front and rear wheels contacts the ground and passes through the original point 0, etc., can be used. If the X-axis on the coordinate plane 304 is set, the orthogonal coordinate system can be easily set by setting a line making Y-axis vertical to the X-axis and passing through the original point 0. A collimation line 400 is when an extending line of the line passing through the original point 0 and the focus f0 and is used to calculate a distance Xd between the landmark 300 and the car when the car passes through the landmark 300 while continuously moving in the current travelling direction.

The photographing apparatus 301 receives the images photographing the landmark 300, the coordinate controller 302 uses the pre-stored information of the photographing apparatus 301 to calculate the distance D between the focus f0 of the photographing apparatus 301 and the landmark 300. In order to calculate D, the coordinate controller 302 can store the magnification of the photographing apparatus 301 and uses the stored magnification information of the photographing apparatus 301 to analyze a point where the line connecting the top end U of the landmark 300 from the focus meets the photographing apparatus 301, that is, the orthogonal coordinate system, thereby generating data having the value of the current coordinate u (Xs, Ys).

When the current coordinate u is generated, the horizontal distance D (that is, distance between the focus ID horizontally connecting the photographing apparatus and the landmark and a point L) between the focus f0 and the landmark is calculated in order to obtain the information of the lane (that is, information as to whether the current car travels on any lane) according to the current coordinate. Since the photographing apparatus 301 is installed in the car, there may be the height ‘h’ from the ground and if the height of the landmark 300 is previously stored in the coordinate controller 32 as H, the difference in height between the photographing apparatus 301 and the landmark 300 will be H-h. In addition, since there is the current coordinate data u, the distance f′ between the horizontal line connecting the landmark 300 from the focus f0 and a point I meeting the coordinate may be defined as follows.

f′=\sqrt{f²+Xs²} [Equation 1]

Thereafter, the horizontal distance D between the focus f0 and the landmark 300 may be calculated using the following equation.

H−h:Ys=D:f′ [Equation 2]

When the horizontal distance D between the focus f0 and the landmark 300 is calculated, the vertical distance Xd between the collimation line 400 and the landmark may be calculated from the following Equation 3.

Xd:Xs=D:f′ [Equation 3]

If the Xd is calculated, the coordinate controller 302 can recognize the number of lanes on which a car is currently positioned based on the Xd and the pre-stored road information.

Through the above calculation, the coordinate controller 302 analyzes the images photographed in the photographing apparatus 301 to generate the current coordinate data and recognizes the number of lanes on which the car is positioned through the current coordinate data to send out the current coordinate data and the current travelling lane data.

The steering control leading apparatus using the landmark according to the exemplary embodiment of the present invention may also include the lane controller 303. The lane controller 303 receives the current coordinate data and the current travelling lane data from the coordinate controller 302 and generates the targeted coordinate data based on the current travelling traffic data and then, compares it with the current data to determine whether the car safely travels the central line of the lane at the lane on which a car is currently positioned. In addition, the lane controller 303 performs a function of sending out the targeted coordinate data and the determined result data as to whether a car travels along the central line of the lane.

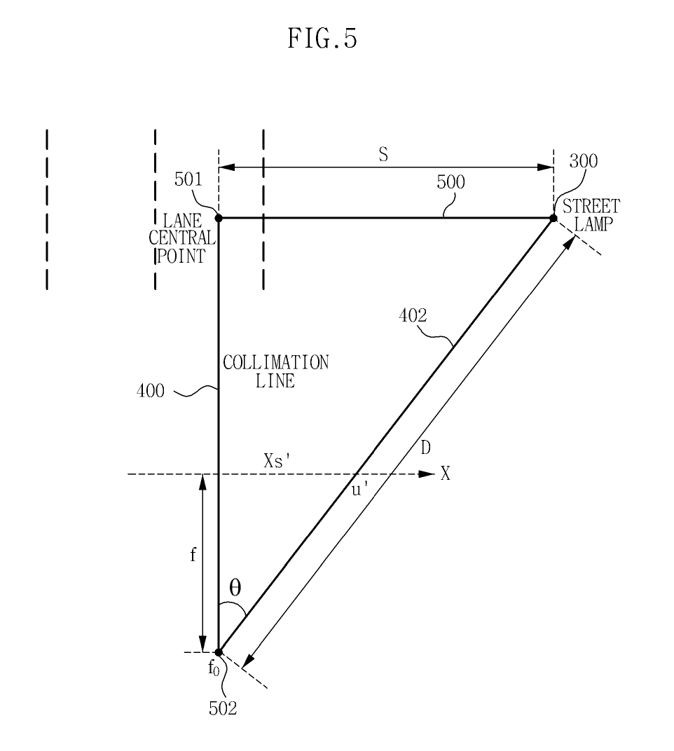

Therefore, the lane controller 303 first performs a function of generating the targeted coordinate data based on the current travelling lane data, which is shown in FIG. 5.

Referring to FIG. 5, the shape when the car travels along the central line of the lane is represented mathematically, which can calculate the targeted coordinate system. First, if the car travels along the central line of the lane, the collimation line 400 shown in FIG. 4 will conform to the central line of the lane connecting between the central points 501 of the lanes.

The lane controller 303 uses the current received travelling traffic data to calculate the vertical distance S between the central line of the current lane and the landmark 300. The lane controller 303 may store the width of each lane and the distance between the landmark 300 and the central line of the outermost lane (in the exemplary embodiment of the present invention, since the landmark 300 exists at the roadside, it means the lane nearest the roadside) for the calculation.

Thereafter, the lane controller 303 uses the current travelling lane data to calculate the horizontal distance between the central line of the current lane and the landmark 300. In the exemplary embodiment of the present invention, since it may be assumed that the distance between the central line of the current lane and the position on which the car currently travels is set to be smaller than 1 m, the distance between the central line of the current lane and the landmark 300 at the current position is assumed to be equal to D calculated in FIG. 4. However, other methods of accurately calculating D in FIG. 5 may be used.

Thereafter, in FIG. 5, an angle θ formed by the central line of the lane and the horizontal line between the focus f0 and the landmark 300 at the targeted coordinate is calculated, wherein each θ may be obtained through the following Equation.

$$θ = {sin}^{- 1} ( \frac{S}{D} ) \qquad [ Equation 4 ]$$

If each θ is calculated, the method for calculating the targeted coordinate (actually, targeted X coordinate) Xs′ is as follows.

D cos(θ):f=S:Xs′ [Equation 5]

Since the focal distance f is the focal distance of the photographing apparatus 301, it may be equal to fin FIG. 4.

The lane controller 303 compares the calculated targeted X coordinate with the X coordinate data among the current coordinate data received from the coordinate controller 302. Since the Y coordinate is not needed to determine whether the car travels along the central line of the lane, only the X coordinate data are considered when the current coordinate data are received. Therefore, in another embodiment of the present invention, when the coordinate controller 302 calculates and generates the current coordinate data, it can calculate and generate only the X coordinate. The lane controller 303 compares the current coordinate data and the targeted X coordinate data to analyze the difference and when the difference deviates from a predetermined value a (for example, 10 cm), may perform a function of transmitting the determined result data information to the driver when current travelling is dangerous.

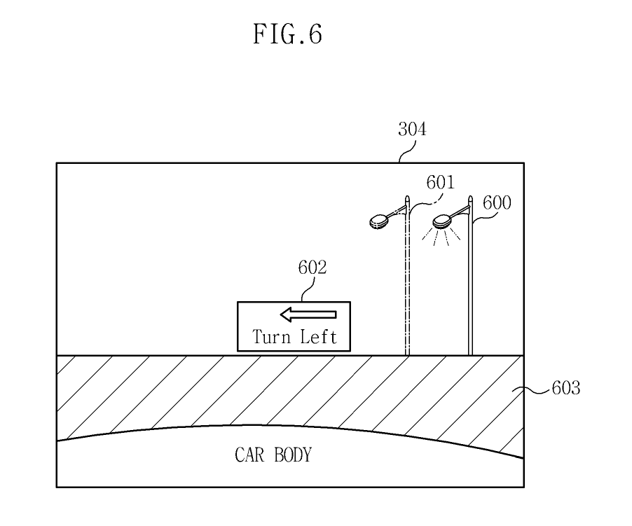

The steering control leading apparatus using the landmark according to the exemplary embodiment of the present invention may include a display unit 304 that displays the current coordinate data and the current travelling lane data received through the coordinate controller 302 or the lane controller 303, the targeted coordinate received from the lane controller 303, and data indicating whether the driving is normally made. An example of the display function of the display unit 304 is shown in FIG. 6.

Referring to FIG. 6, the display unit 304 receives the current coordinate data from the coordinate controller 302 and analyzes this, thereby displaying the photographed images. In the exemplary embodiment of the present invention, the first position image 600 of the landmark corresponding to the current coordinate data is displayed in the display unit. The targeted coordinate data is received from the lane controller 303, which is displayed as the second position image 601 of the landmark. Although the exemplary embodiment of the present invention displays the substantial landmark image as shown in FIG. 6, the method of directly displaying the coordinates or not displaying the image may also be used.

The display unit 304 may display the determined result data as to whether a car is normally driven, which is received from the lane controller 303. The display unit 304 can display the determined results as to whether a car travels along the central line of the lane. In the exemplary embodiment of the present invention, nothing is displayed on the display unit 304 in the normal driving state and when a car deviates from the central line of the lane by the predetermined range (for example, 10 cm), the command to control the steering left to right is displayed on the display unit 304, depending on the position of the targeted coordinate. In addition to this, in order for the driver to drive a car along the central line of the lane, a method of transmitting information to the driver may include at least one of vibration, sound, and other visual representations. Alternatively, the method of limiting the steering by the automatic driving control system of the car or the method of allowing the car to directly control the steering instead of the driver may be used.

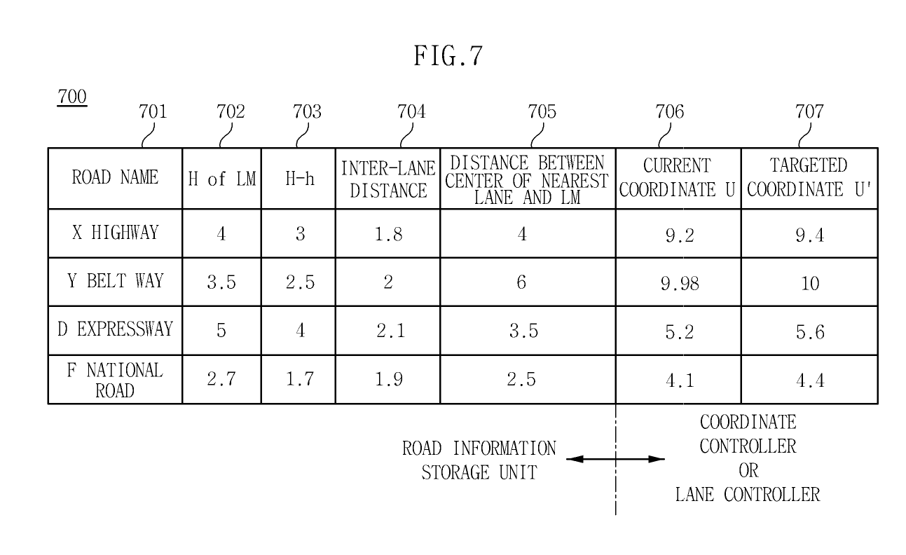

Another exemplary embodiment of the present invention may further include a road information storage unit 305 that pre-stores information necessary to generate at least one of the coordinate data of the above-mentioned coordinate controller 302 and the lane controller 303, the travelling lane data, and the data indicating as to whether a car is normally driven. An example of the data base structure of the road information storage unit 305 is shown in FIG. 7.

Referring to FIG. 7, since the landmark may be constant or varied according to the road situation, it may include data 701 for a road name and may also include data 702 for the size of the landmark according to the road name. In addition, since the height from the ground to the photographing apparatus for each car may be different, it may also include data 703 which relates to the difference between the height of the landmark and the height of the photographing apparatus when the photographing apparatus is initially installed by user's input. The distance data 704 between the lanes are stored in the road information storage unit 305 instead of the coordinate controller and may be supplied according to the demand of the coordinate controller and data 705 for the distance between the center of the nearest lane and the landmark, that is, the outermost lane when the landmark is installed at the roadside, the distance between the center of 1 lane and the landmark when the landmark is installed at the central line may be provided to the coordinate controller and the lane controller, respectively. In addition, a current coordinate data 706 or a targeted coordinate data 707 may also be included. The road information storage unit 305 may additionally store non-explained data necessary to practice the present invention. If the information is stored in the road information storage unit 305, the operation of the coordinate controller and the lane controller may be made easier. The current coordinate data 706 or the targeted coordinate data 707 may be separately stored in the coordinate controller 302 or the lane controller 303, respectively.

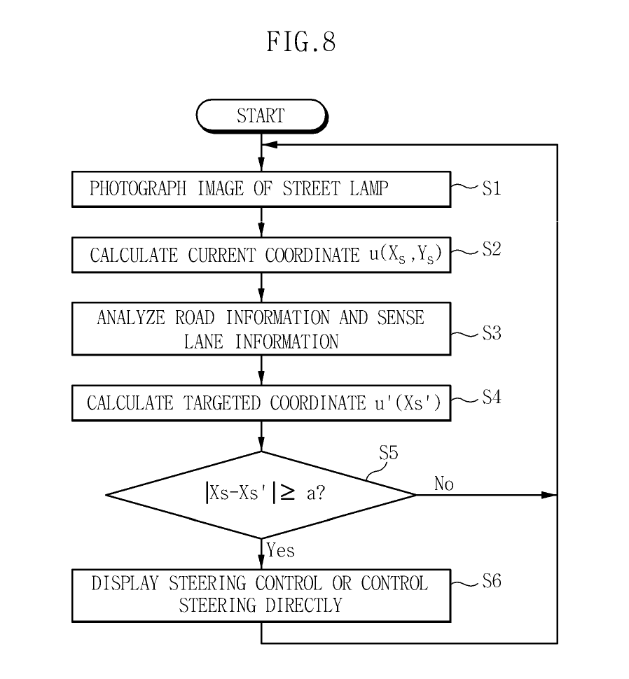

FIG. 8 shows a schematic flow chart of the steering control method using the steering control leading apparatus using the landmark according to the exemplary embodiment of the present invention. In the present invention, the steering control method is a concept including the steering control method for following within the lane. In performing the functions for each step, the steering control leading apparatus using the landmark according to the exemplary embodiment of the present invention has been described and therefore, the portion overlapped with the description of the steering control leading apparatus using the above-mentioned landmark will be omitted.

First, the photographing apparatus 301 performs a step S1 of photographing images for the landmark 300. The step S1 of photographing the landmark 300 by the photographing apparatus is periodically performed according to the interval where the landmark 300 is installed or as shown in FIG. 8, after all the operations and determinations end, it can recognize again the landmark 300 and photograph it. Thereafter, a step S2 of analyzing the image data photographed by the photographing apparatus 301 and generating the current coordinate data u (Xs, Ys) according to the operation performance of the above-mentioned coordinate controller 302 is performed. If the current coordinate data u is generated, the coordinate controller 302 receives the road information (including all information included in the database of FIG. 7) from at least one of the databases of the coordinate controller 302, the road information storage unit 305, and the lane controller 303 and analyzes it, such that it performs step S3 of generating the lane information, that is, current travelling lane data.

The lane controller 303 receives the current coordinate data and current travelling lane data from the coordinate controller 302 and the coordinate controller 302 receives the road information from at least one of the databases of the coordinate controller 302, the road information storage unit 305, and the lane controller 303 except for the current coordinate data and the current travelling lane data and performs step S4 for calculating and generating the targeted coordinate u′ (Xs′) data through the above-mentioned operation method based thereon Thereafter, the lane controller 303 performs step S5 for calculating the difference between the X coordinate Xs and the targeted coordinate Xs′ of the current coordinate data and determining whether the difference deviates from the constant value a (for example, 10 cm). When the difference between the X coordinate Xs and the targeted coordinate Xs′ of the current coordinate data is the predetermined value a or more, step (S6) for displaying to user through the display unit 305 in order to control the steering or directly controlling the steering by the automatic control system of the car is performed. Thereafter, step (S1) for photographing the landmark 300 is performed again.

The description of the method to practice the steering control leading apparatus using the landmark according to the exemplary embodiments of the present invention is given by way of example only and therefore, does not limit the scope of the present invention. Further, in addition to the foregoing exemplary embodiments, the equivalent inventions performing the same function as the present invention should be construed as being included in the scope of the present invention.

What is claimed is:

1. A steering control leading apparatus using a landmark, comprising:
a coordinate controller that analyzes images obtained by photographing the landmark installed on a road by a photographing apparatus installed in a car to generate current coordinate data and current driving lane data of a car;
a lane controller that compares at least one of targeted coordinate data, current coordinate data, and current driving lane data of the car to determine whether the car is normally driven and generates data indicating whether the car is normally driven; and
a display unit that displays at least one of current coordinate data, and current driving lane data, targeted coordinate data, and data indicating whether the car is normally driven.

2. The steering control leading apparatus using a landmark according to claim 1, wherein the landmark is a street lamp that is installed at a roadside or a center lane at a predetermined interval.

3. The steering control leading apparatus using a landmark according to claim 1, wherein the landmark is a mark having a predetermined height that is installed at a roadside or a center lane.

4. The steering control leading apparatus using a landmark according to claim 1, wherein the photographing apparatus is a camera that is installed at the front center of the car.

5. The steering control leading apparatus using a landmark according to claim 1, wherein the coordinate controller sets an orthogonal coordinate system by setting the central point of the photographing apparatus as an original point and setting a line horizontal to the road surface and a line meeting the center point of the photographing apparatus as an X-axis.

6. The steering control leading apparatus using a landmark according to claim 1, wherein the coordinate controller generates a coordinate of a point where a line connecting between the focus of the photographing apparatus and the top end of the landmark meets the orthogonal coordinate system set based on the photographing apparatus as current coordinate data.

7. The steering control leading apparatus using a landmark according to claim 6, wherein the coordinate controller calculates a vertical distance between a line connecting the focus and the central point of the photographing apparatus and the landmark based on at least one of current coordinate data, the horizontal distance between the focus of the photographing apparatus and the landmark, and the distance between the focus of the photographing apparatus and the point where the line connecting the landmarks meets the current coordinate and generates current driving lane data based on the calculated vertical distance and the stored road information.

8. The steering control leading apparatus using a landmark according to claim 1, wherein the lane controller generates the central point of the traffic line at the current position of the car as an original point, the vertical line direction between the line forming the central point of the lane and the landmark as an X-axis, and the coordinate of the point where the X-axis meets the line parallel with the ground connecting between the central point of the lane at the current position of the car and the landmark as targeted coordinate data.

9. The steering control leading apparatus using a landmark according to claim 1, wherein the steering control leading apparatus using the landmark further includes a road information storage unit that updates and stores the road information necessary to generate at least one of current coordinate data, the current travelling lane information, and the targeted coordinate data in real time.

10. The steering control leading apparatus using a landmark according to claim 9, wherein the road information is at least one of a road name, a height of the landmark for each road, an actual difference in height between the landmark and the photographing apparatus, an inter-lane distance, and the distance between the central line of the lane nearest the landmark and the landmark.

11. A steering control method using a landmark, comprising:
analyzing, by a coordinate controller, images photographing the landmark installed on a road by a photographing apparatus to generate current coordinate data or current driving lane data of a car;
generating, by a lane controller, a targeted coordinate data of a car;
comparing, by the lane controller, targeted coordinate data with current coordinate data received from the coordinate controller to determine whether a car is normally driven; and
displaying, by a display unit, at least one of current coordinate data received from the coordinate controller, targeted coordinate data received from the lane controller, and the data indicating whether a car is normally driven.

12. The steering control method using a landmark according to claim 11, wherein the landmark is a street lamp installed at a roadside or a center lane at a predetermined interval.

13. The steering control method using a landmark according to claim 11, wherein the landmark is a mark having a predetermined height that is installed at a roadside or a center lane.

14. The steering control method using a landmark according to claim 11, wherein the photographing apparatus is a camera that is installed at the front center of the car.

15. The steering control method using a landmark according to claim 11, wherein the generating the current coordinate data sets an orthogonal coordinate system by setting the central point of the photographing apparatus as an original point and setting a line horizontal to the road surface and a line meeting the center point of the photographing apparatus as an X-axis.

16. The steering control method using a landmark according to claim 11, wherein the generating the current coordinate data generates a coordinate of a point where a line connecting between the focus of the photographing apparatus and the top end of the landmark meets the coordinate system generated based on the photographing apparatus as the current coordinate data.

17. The steering control method using a landmark according to claim 16, wherein the generating the current coordinate data calculates a vertical distance between a line connecting the focus and the central point of the photographing apparatus and the landmark based on at least one of the current coordinate data, the horizontal distance between the focus of the photographing apparatus and the landmark, and the distance between the focus of the photographing apparatus and the point where the line connecting the landmarks meets the current coordinate and generates current driving lane data based on the calculated vertical distance and the stored road information.

18. The steering control method using a landmark according to claim 11, wherein the generating the targeted coordinate data includes:
generating the central point of the traffic line at the current position of the car as an original point and the vertical line direction between the line forming the central point of the lane and the landmark as an X-axis; and generating the coordinate of the point where the X-axis meets the line parallel with the ground connecting between the central point of the lane at the current position of the car and the landmark as the targeted coordinate data.

19. The steering control method using a landmark according to claim 11, further updating and storing the road information necessary to generate at least one of current coordinate data, current driving lane data, and targeted coordinate data in the road information storage unit in real time.

20. The steering control method using a landmark according to claim 19, wherein the road information is at least one of a road name, a height of the landmark for each road, an actual difference in height between the landmark and the photographing apparatus, an inter-lane distance, and the distance between the central line of the lane nearest the landmark and the landmark.
